(19) United States
(12) Patent Application Publication
(10) Pub. No.: US 2026/0091657 A1
(43) Pub. Date: Apr. 2, 2026

(54) Clip-On Dual Swingable Vehicle Visor Apparatus for Providing Simultaneous Multidimensional Sunshade

(71) Applicant: Patrick Pernia, San Jose, CA (US)

(72) Inventor: Patrick Pernia, San Jose, CA (US)

(21) Appl. No.: 19/012,527

(22) Filed: Jan. 7, 2025

Related U.S. Application Data
(60) Provisional application No. 63/702,094, filed on Oct. 1, 2024.

(51) Int. Cl. B60J 3/02

(52) U.S. Cl. CPC B60J 3/0208; B60J 3/0221; B60J 3/026

(57) ABSTRACT

A clip-on dual swingable vehicle visor apparatus incorporates a baseboard that clips onto a standard in-car sun visor, and further incorporates a frontal visor and a removable side visor to operate as simultaneous multidimensional sunshades. The side edges of the baseboard uniquely feature rails that are designed to dock with a sliding clip connected to the side visor, which constitutes a modular and easily-removable side visor structure that can be readily attached or detached from the left or the right side of the baseboard to accommodate a flexible application of the visor apparatus on either the driver-side or the front passenger-side standard in-car sun visor, depending on users' needs and preferences. Furthermore, both the frontal visor and the removable side visor may be tinted at specific visible light transmission (VLT) levels based on manufacturer or user preferences to provide a desirable level of reduction in solar intensity and energy.

### BACKGROUND OF THE INVENTION

The present invention generally relates to a sun visor. More specifically, the present invention relates to various embodiments of a uniquely-structured dual swingable vehicle visor apparatus that are attachable to standard in-car sun visors.

Most vehicles on the road today are equipped with standard in-car sun visors, which are provided as a standard equipment by vehicle manufacturers. Typically, a standard in-car sun visor (i.e. also called interchangeably herein as the “factory visor”) provides partial sun blockage or sunshade to an upper portion of a front windshield in a vehicle. Furthermore, the standard in-car sun visor can swing around to a side window to also provide a partial sun blockage or sunshade to an upper portion of the side window. Most vehicles have at least one standard in-car sun visor for a driver's seat and a front passenger seat.

However, the standard in-car sun visor is incapable of providing sun blockage or sunshade to two or more dimensions at the same time. For example, a driver who is making a turn is often inconvenienced by a blinding sunlight that is shining from a different direction during or after the turn. In such situations, the driver compromises safety by facing the blinding sunlight while changing directions, or by attempting to swing the standard in-car sun visor around (e.g. from the front windshield to the driver's side window, or vice versa) while changing directions. The standard in-car sun visor's inability to provide sun block or sunshade to two or more dimensions simultaneously is an inherent and significant safety risk and a user inconvenience to many drivers today.

There have been some attempts to resolve this inconvenience in the past. For example, attachable sunshades with air suction cups or static adhesion-inducing elements are widely available in the car accessory market today. These conventional aftermarket sunshade products typically attach to a side window of a vehicle to provide sun blockage or sunshade. However, if the driver or the front passenger of the vehicle accidentally opens the side window attached with a conventional aftermarket sunshade with air suction cups or static adhesion-induing elements, the conventional aftermarket sunshade can be abruptly dislocated or dislodged from the side window, thereby introducing additional inconvenience and even safety risks associated with the abruptly-dislodged aftermarket sunshade. Furthermore, the vehicle's interior may be also damaged by accidental opening of the side window attached with the conventional aftermarket sunshade.

Therefore, it may be advantageous to provide a novel attachable and removable vehicle visor apparatus that does not dislocate or dislodge even when a side window is opened or closed. Furthermore, it may also be advantageous to provide a novel vehicle visor apparatus that attaches to an existing standard in-car sun visor (i.e. “factory visor”) to form a unique multidimensional sun visor structure that can provide simultaneous and multidimensional sun-shading or sun blockage while in use.

Moreover, it may also be advantageous to provide a novel attachable and removable vehicle visor apparatus incorporating dual tinted visors that can provide a sun-shaded (i.e. tinted) and/or translucent view of the front windshield and the side window simultaneously, instead of potentially hampering the user's line of sight by completely blocking the sunlight with conventional opaque standard in-car sun visors. Furthermore, it may also be advantageous to provide various shade levels (i.e. visible light transmission (VLT) levels ranging from slight tinting to fully opaque) on these dual tinted visors based on user preferences or application requirements.

In addition, it may also be advantageous to provide a novel attachable and removable vehicle visor apparatus that can be folded or stored together with the existing standard in-car sun visor while not in use.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In one embodiment of the invention, a clip-on dual swingable vehicle visor apparatus is disclosed. This apparatus comprises: (1) a baseboard configured to be clipped onto a standard in-car sun visor and positioned in parallel above or below the standard in-car sun visor; (2) a left-side rail incorporated in a left-side edge of the baseboard, and a right-side rail incorporated in a right-side edge of the baseboard; (3) a sliding clip configured to slide into and slide out of the left-side rail or the right-side rail of the baseboard; (4) a side visor operatively attached to the sliding clip as a removable side visor structure, wherein the sliding clip in the removable side visor structure is configured to dock into the left-side rail to operate as a driver-side or left-side sunshade in a first usage application, and wherein the sliding clip in the removable side visor structure is configured to dock into the right-side rail to operate as a front passenger-side or right-side sunshade in a second usage application; (5) a frontal visor operatively attached to the baseboard to serve as a frontal sunshade; and (6) a frontal visor clip operatively attached to the baseboard, wherein the frontal visor clip is configured to bind the baseboard to the standard in-car sun visor by clipping the baseboard onto a bottom or top surface of the standard in-car sun visor.

### BRIEF DESCRIPTION OF DRAWINGS

FIG. 1 shows a perspective view of a clip-on dual swingable vehicle visor apparatus, in accordance with an embodiment of the invention.

FIG. 2 shows an isolated perspective view of a baseboard incorporating rails to accommodate sliding clips associated with a tinted side visor, which is a component of the clip-on dual swingable vehicle visor apparatus, in accordance with an embodiment of the invention.

FIG. 3 shows a vehicle interior view of the clip-on dual swingable vehicle visor apparatus in full extension mode while being clipped onto a driver-side factory visor, in accordance with an embodiment of the invention.

FIG. 4 shows a vehicle interior view of the clip-on dual swingable vehicle visor apparatus in a partial extension mode while being clipped onto the driver-side factory visor, in accordance with an embodiment of the invention.

FIG. 5 shows a vehicle interior view of the clip-on dual swingable vehicle visor apparatus in another partial extension mode while being clipped onto the driver-side factory visor, in accordance with an embodiment of the invention.

FIG. 6 shows a vehicle interior view of the clip-on dual swingable vehicle visor apparatus in full retraction mode while being clipped onto the driver-side factory visor, in accordance with another embodiment of the invention.

FIG. 7 shows a vehicle interior view of the clip-on dual swingable vehicle visor apparatus in full retraction mode while being clipped onto a front passenger-side factory visor, in accordance with another embodiment of the invention.

FIG. 8 shows a vehicle interior view of the clip-on dual swingable vehicle visor apparatus in full extension mode while being clipped onto the front passenger-side factory visor, in accordance with another embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of descriptions of shapes, configurations, and/or other symbolic representations that directly or indirectly resemble one or more clip-on dual swingable vehicle visor apparatuses in accordance with one or more embodiments of the invention. These process descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order and do not imply any limitations in the invention.

One objective of an embodiment of the present invention is to provide a novel attachable and removable vehicle visor apparatus that does not dislocate or dislodge even when a side window is opened or closed.

Another objective of an embodiment of the present invention is to provide a novel attachable and removable vehicle visor apparatus that can be easily attached to an existing standard in-car sun visor (i.e. “factory visor”) to form a unique multidimensional sun visor structure that can provide simultaneous and multidimensional sun-shading or sun blockage while in use.

A further objective of an embodiment of the present invention is to provide a novel attachable and removable vehicle visor apparatus incorporating dual tinted visors that can provide a sun-shaded (i.e. tinted) and/or translucent view of the front windshield and the side window simultaneously, instead of potentially hampering the user's line of sight by completely blocking the sunlight with a conventional opaque standard in-car sun visor.

A further objective of an embodiment of the present invention is to provide various shade levels (i.e. visible light transmission (VLT) levels ranging from slight tinting to fully opaque) on the dual tinted visors in the vehicle visor apparatus based on user preferences or application requirements.

Another objective of an embodiment of the present invention is to provide a novel attachable and removable vehicle visor apparatus that can be folded or stored together with the existing standard in-car sun visor while not in use.

For the purpose of describing the invention, a term “visor” is defined as a panel of a device, or the device itself, wherein each visor is capable of at least partially reducing or blocking the sun's intensity. For example, a frontal visor is a panel that reduces or blocks the sun's intensity coming through a vehicle's front windshield for the area covered by the panel. In another example, a side visor is a panel that reduces or blocks the sun's intensity coming through a vehicle's side window for the area covered by the panel.

Furthermore, for the purpose of describing the invention, a term “sunshade” is defined as a protective covering that reduces or blocks the sun's intensity (i.e. solar energy). In one example, a sunshade can be tinted in dark color to reduce the sun's intensity while providing some levels of visibility through the sunshade. In another example, a sunshade may be completely opaque, and not provide any substantial visibility through the sunshade.

Moreover, for the purpose of describing the invention, a term “tint,” or “tinting” is defined as reducing the magnitude of visible light transmission (VLT) or visible light transmissivity on a visor's surface by darkening and/or altering the native transparency of the visor's surface. For example, in a preferred embodiment of the invention, a VLT of seventy percent (70%) is defined as allowing seventy percent of visible light transmission, while reducing and/or blocking thirty percent (30%) of visible light transmission through the visor's surface. In another example, a VLT of twenty percent (20%) is defined as allowing twenty percent of visible light transmission, while reducing and/or blocking eighty percent (80%) of visible light transmission through the visor's surface. A tinted surface with a lower VLT number results in a darker shade level and less visible light transmission/transmissivity, while a higher VLT number results in a lighter shade level and more visible light transmission/transmissivity. By definition, a VLT of one hundred percent (100%) means a complete visible light transmissivity with total transparency, while a VLT of zero (0%) means no visible light transmissivity and a total opaqueness.

Furthermore, for the purpose of describing the invention, a term “rail” is defined, in a preferred embodiment of the invention, as a bar or a series of bars on a baseboard, wherein the bar is configured to dock with a sliding clip connected to a side visor to constitute a modular and easily-removable structure for a clip-on dual swingable vehicle visor apparatus. In an alternate embodiment of the invention, the term “rail” may instead be defined as a magnetic element, a Velcro strip or element, a button, a hook, a fastener, or another structural element configured to attach to or dock with a sliding clip connected to a side visor to constitute a modular and easily-removable structure for a clip-on dual swingable vehicle visor apparatus.

Additionally, for the purpose of describing the invention, a term “sliding clip” is defined, in a preferred embodiment of the invention, as a device configured to slide into or latch onto a corresponding rail located on a baseboard to constitute a modular and easily-removable structure for a clip-on dual swingable vehicle visor apparatus. In an alternate embodiment of the invention, the term “sliding clip” may instead be defined as a magnetic element, a Velcro strip, a button, a hook, a fastener, or another structural element configured to attach to or dock with a corresponding attachment element (i.e. “rail”) on a baseboard to constitute a modular and easily-removable structure for a clip-on dual swingable vehicle visor apparatus.

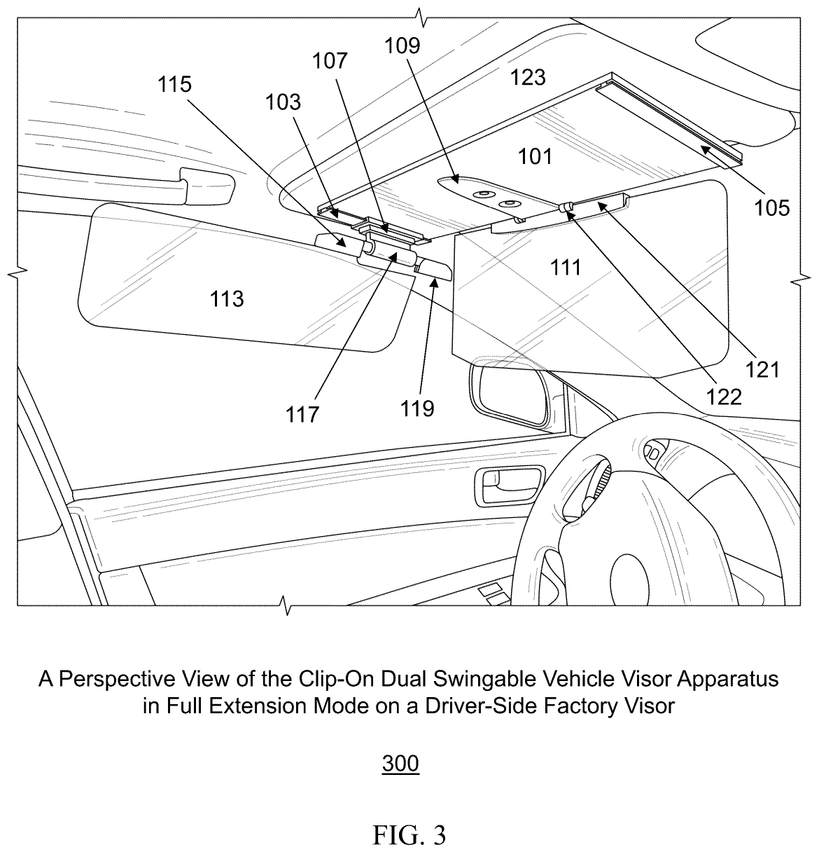

Moreover, for the purpose of describing the invention, a term “baseboard” is defined as a plank made of plastic, rubber, wood, or another solid material that serves as a base panel that anchors and structurally supports a frontal visor unit and a side visor unit to constitute basic modular structures of a clip-on dual swingable vehicle visor apparatus. In a preferred embodiment of the invention, the baseboard incorporates a left-side edge rail and a right-side edge rail to accommodate docking with the side visor's sliding clip on either side edges of the baseboard. The baseboard may also incorporate a frontal visor clip that attaches the frontal visor to the baseboard and also enables the baseboard to clip onto a factory visor (i.e. a standard in-car sun visor), as illustrated, for example, in FIG. 3˜8.

In addition, for the purpose of describing the invention, a term “clip-on” is defined as capable of being attached to an object with a clip. Typically, a clip-on device is easily attachable or detachable to an object by widening or narrowing the width of the clip.

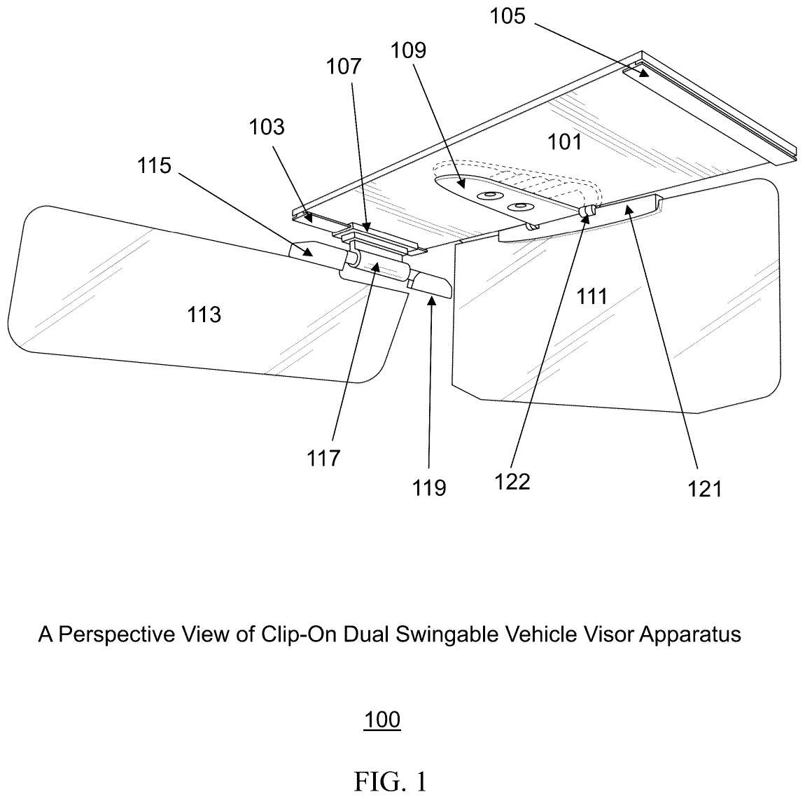

FIG. 1 shows a perspective view (100) of a clip-on dual swingable vehicle visor apparatus, in accordance with an embodiment of the invention. In a preferred embodiment of the invention as shown in FIG. 1, the clip-on dual swingable vehicle visor apparatus comprises a baseboard (101), which is a plank made of plastic, rubber, wood, or another solid material. The baseboard (101) serves as a base panel of the clip-on dual swingable vehicle visor apparatus, and anchors and structurally supports a frontal visor (111) attached to a frontal visor holder (121) and a frontal visor clip (109) with a frontal visor pivot (122), which is at least partially encapsulated by the frontal visor holder (121) and the frontal visor clip (109), as illustrated in FIG. 1. The baseboard (101) also serves as the base panel that anchors and structurally supports a side visor (113), which is attached to a sliding clip (107) incorporating a side visor pivot holder (117) with a side visor pivot (115) that penetrates through the side visor pivot holder (117), as also illustrated in FIG. 1.

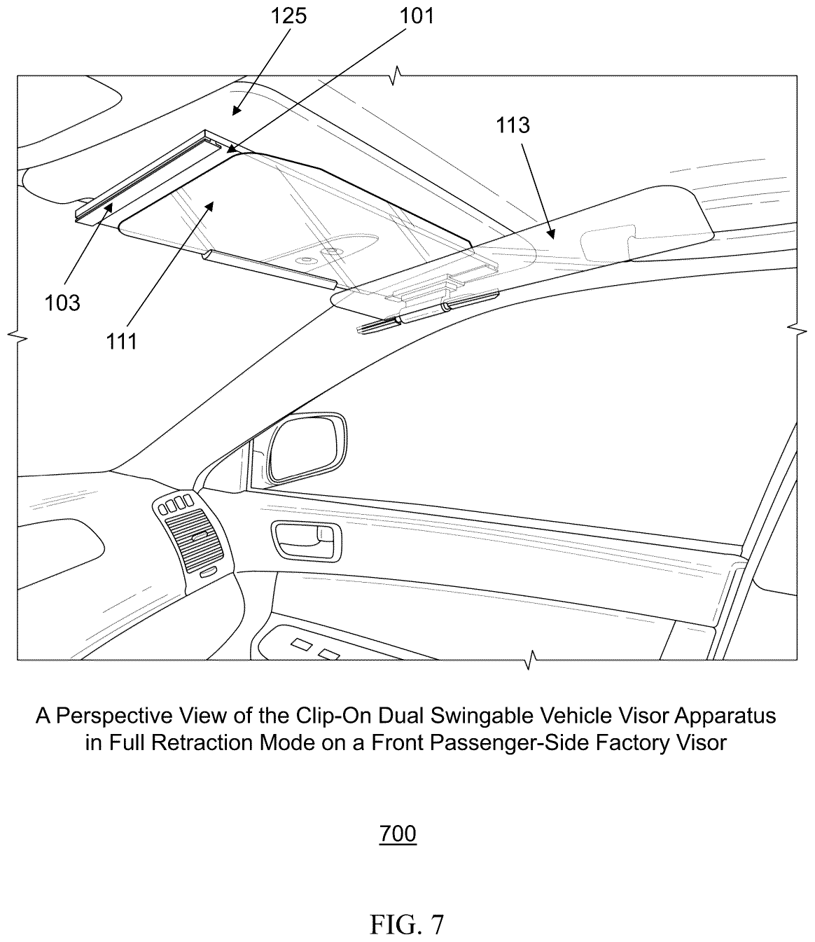

In the preferred embodiment of the invention as shown in FIG. 1, the baseboard (101) also incorporates a left-side rail (103) and a right-side rail (105) on side edges of the baseboard (101) to enable the sliding clip (107) operatively attached to the side visor (113) to be easily yet securely attached or detached from either side edges of the baseboard (101). In particular, the side visor (113) incorporating the sliding clip (107) can be easily and securely slid into or slid out of either the left-side rail (103) or the right-side rail (105), depending on a user's desired application. For example, if the user intends to utilize the clip-on dual swingable vehicle visor apparatus on a driver-side factory visor, as shown in FIG. 3˜6, then the side visor (113) incorporating the sliding clip (107) may be slid into the left-side rail (103) of the baseboard (101), as shown in FIG. 1. In contrast, if the user intends to utilize the clip-on dual swingable vehicle visor apparatus on a front passenger-side factory visor, then the side visor (113) incorporating the sliding clip (107) may be slid into the right-side rail (105) of the baseboard (101), as shown in FIG. 7˜8.

Furthermore, as shown in the preferred embodiment of the invention in FIG. 1, the angle of the side visor (113) is configured to be adjusted around the side visor pivot (115) and the side visor pivot holder (117) based on user preferences, with the side visor pivot (115) and the side visor pivot holder (117) as the side visor's (113) axis of rotation. Moreover, the angle of the frontal visor (111) is configured to be adjusted around the frontal visor pivot (122) held across horizontally and encapsulated by the frontal visor holder (121) and the frontal visor clip (109). Moreover, the frontal visor clip (109), which may be screwed onto or firmly attached to the baseboard (101), is configured to be “clipped onto” a factory visor, wherein an upper portion of the frontal visor clip (109), illustrated in perforated lines in FIG. 1, is specifically designed to be securely and removably clipped onto and over a factory visor, as exemplified in FIG. 3˜8.

In the preferred embodiment of the invention, the frontal visor clip (109) and the baseboard (101) are two separate parts attached or screwed on together. In other embodiments of the invention, the frontal visor clip (109) and the baseboard (101) may be a single molded piece or a singular part for cost efficiency and part count reductions. Similarly, in the preferred embodiment of the invention, the frontal visor (111) and the frontal visor holder (121) may be two separate parts attached together, while in other embodiments of the invention, they may be a single molded piece or a singular part for cost efficiency and part count reductions. Likewise, in the preferred embodiment of the invention, the side visor (113), the side visor pivot (115), the side visor pivot holder (117), and the sliding clip (107) may be separate parts assembled together, while in other embodiments of the invention, at least some of those parts may be combined and molded pieces for cost efficiency and part count reductions.

Furthermore, in some alternate embodiments of the invention, the frontal visor (111) may be operatively attached to the baseboard (101) with a frontal rail on the baseboard (101) and a frontal sliding clip for the frontal visor (111), instead of being operatively attached to the baseboard (101) using the frontal visor holder (121), the frontal visor pivot (122), and the frontal visor clip (109) as described and illustrated for the preferred embodiment of the invention. Yet in other alternate embodiments of the invention, the frontal visor (111) may be operatively attached to the baseboard (101) with other methods of attachments, such as magnets, Velcro strips, buttons, hooks, or fasteners.

In the preferred embodiment of the invention, the frontal visor (111) and the side visor (113) may be partially transparent or completely opaque, depending on a manufacturer or user preference for achieving a particular level of sun intensity reduction or blockage. For example, each visor (i.e. 111 or 113) can be made of acrylic, plastic, glass, or another transparent material, and can be tinted at a specific visible light transmission (VLT) level. Furthermore, each visor may be a tinted plastic piece, a translucent plastic piece, an opaque plastic piece, or a piece made from other materials that provide substantial amount of cover from the sun's intensity.

Reducing the magnitude of visible light transmission (VLT) on a visor's surface is typically achieved by darkening and/or altering the native transparency of the visor's surface. For instance, a VLT of seventy percent (70%) allows seventy percent of visible light transmission, while reducing and/or blocking thirty percent (30%) of visible light transmission through the visor's surface. In another example, a VLT of twenty percent (20%) allows twenty percent of visible light transmission, while reducing and/or blocking eighty percent (80%) of visible light transmission through the visor's surface.

In general, a tinted visor with a lower VLT number results in a darker shade level and less visible light transmission, while a higher VLT number results in a lighter shade level and more visible light transmission. By definition, a VLT of one hundred percent (100%) means a complete visible light transmissivity with total transparency, while a VLT of zero (0%) means no visible light transmissivity and a total opaqueness. Furthermore, in some embodiments of the invention, the clip-on dual swingable vehicle visor apparatus also incorporates an optional adjustment tab (119), which may be configured to adjust pivot resistance (i.e. rotation firmness) of the side visor pivot (115), lock the angle of the side visor (113), or lock the current position of the sliding clip (107) on the left-side rail (103) when the optional adjustment tab (119) is turned or twisted to a designated position.

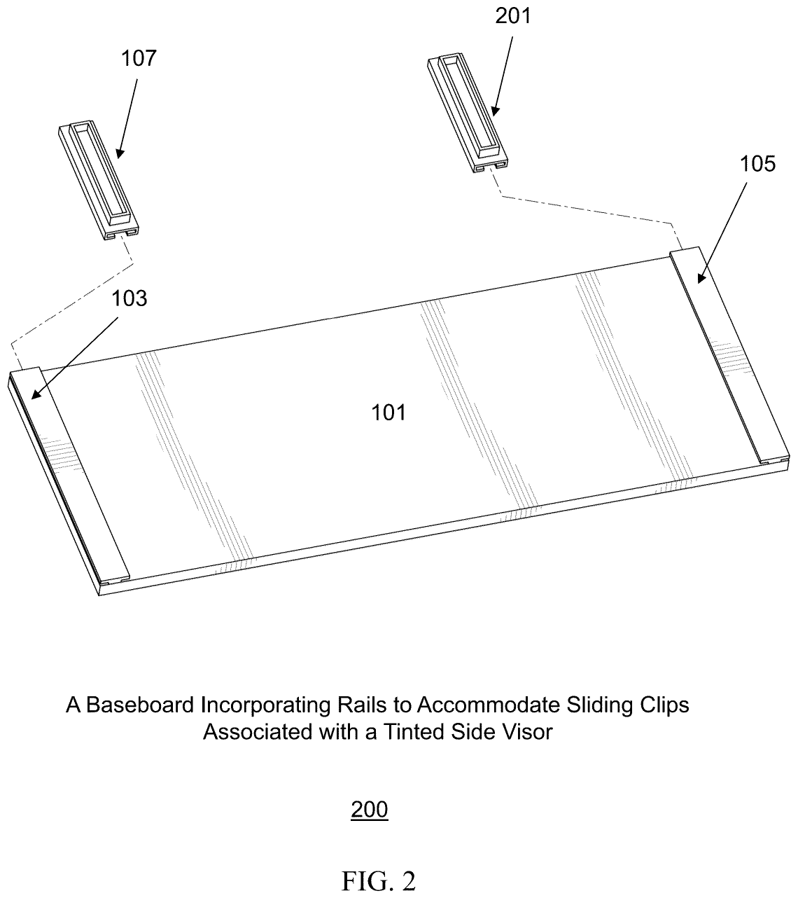

FIG. 2 shows an isolated perspective view (200) of the baseboard (101) incorporating two side edge rails (e.g. 103, 105) to accommodate corresponding sliding clips (e.g. 107, 201) associated with a tinted side visor (e.g. 113 in FIG. 1 and FIG. 3˜8), which is a component of the clip-on dual swingable vehicle visor apparatus, in accordance with an embodiment of the invention. The baseboard (101) is a plank that serves as a base panel made of plastic, rubber, wood, or another solid material.

As shown in FIG. 2, the baseboard (101) incorporates the left-side rail (103) and the right-side rail (105) on the side edges of the baseboard (101), and each rail is configured to dock with a corresponding sliding clip (i.e. 107 or 201) operatively attached to the side visor (i.e. 113 in FIG. 1). The incorporation of rails on both side edges of the baseboard (101) enables convenient docking or removal of the side visor from either side of the baseboard (101), and enhances the usefulness of the clip-on dual swingable vehicle visor apparatus, whether it is clipped onto a driver-side factory visor, as illustrated in FIG. 3˜6, or onto a front passenger-side factory visor, as illustrated in FIG. 7˜8. Furthermore, the baseboard (101) is configured to anchor and structurally support attachments of the frontal visor (i.e. 111 in FIG. 1) as well as the side visor (i.e. 113 in FIG. 1), which in combination constitutes basic modular structures of the clip-on dual swingable vehicle visor apparatus.

Although the left-side rail (103) and the right-side rail (105) on the side edges of the baseboard (101), as depicted in FIG. 2 to illustrate the preferred embodiment of the invention, fit the previously-described intrinsic definition of the term “rail” as being a bar or a series of bars on a baseboard, “rails” in alternate embodiments of the invention may instead be magnetic elements, Velcro elements, buttons, hooks, fasteners, or other structural elements designed to attach to or dock with one or more sliding clips connected to the side visor. Likewise, although the sliding clips (i.e. 107, 201), as depicted in FIG. 2 to illustrate the preferred embodiment of the invention, fit the previously-described intrinsic definition of the term “sliding clip” as each being a device configured to slide into or latch onto a corresponding rail (i.e. 103, 105) located on the baseboard (101), “sliding clips” in alternate embodiments of the invention may instead be magnetic elements, Velcro elements/strips, buttons, hooks, fasteners, or other structural elements designed to attach to or dock with a corresponding attachment element (i.e. “rail”) on a baseboard.

FIG. 3 shows a vehicle interior view (300) of the clip-on dual swingable vehicle visor apparatus in full extension mode while being clipped onto a driver-side factory visor (123), in accordance with an embodiment of the invention. In the preferred embodiment of the invention as shown in FIG. 3, the clip-on dual swingable vehicle visor apparatus comprises the baseboard (101), the frontal visor (111) operatively attached to the baseboard (101) via the frontal visor holder (121) and the frontal visor clip (109), and the side visor (113) operatively attached to the baseboard (101) via the side visor pivot (115), the side visor pivot holder (117), and the sliding clip (107), which is slid into a secure position on the left-side rail (103) on the baseboard (101), as illustrated in FIG. 3.

In the preferred embodiment of the invention, the baseboard (101) is a plank made of plastic, rubber, wood, or another solid material. The baseboard (101) serves as a base panel of the clip-on dual swingable vehicle visor apparatus, and anchors and structurally supports the frontal visor (111) attached to the frontal visor holder (121) and the frontal visor clip (109) with the frontal visor pivot (122), which is encapsulated by the frontal visor holder (121) and the frontal visor clip (109), as illustrated in FIG. 3. The baseboard (101) also serves as the base panel that anchors and structurally supports the side visor (113), which is attached to the sliding clip (107) incorporating the side visor pivot holder (117) with the side visor pivot (115) that penetrates through the side visor pivot holder (117), as also illustrated in FIG. 3.

In the embodiment of the invention as shown in FIG. 3, the baseboard (101) also incorporates the left-side rail (103) and the right-side rail (105) on side edges of the baseboard (101) to enable the sliding clip (107) operatively attached to the side visor (113) to be easily yet securely attached or detached from either side edges of the baseboard (101). In particular, the side visor (113) incorporating the sliding clip (107) can be easily and securely slid into or slid out of either the left-side rail (103) or the right-side rail (105), depending on a user's desired application. For example, if the user intends to utilize the clip-on dual swingable vehicle visor apparatus on a driver-side factory visor, as shown in FIG. 3˜6, then the side visor (113) incorporating the sliding clip (107) may be slid into the left-side rail (103) of the baseboard (101), as shown in FIG. 3. In contrast, if the user intends to utilize the clip-on dual swingable vehicle visor apparatus on a front passenger-side factory visor, then the side visor (113) incorporating the sliding clip (107) may be slid into the right-side rail (105) of the baseboard (101), as shown in FIG. 7˜8.

Furthermore, the clip-on dual swingable vehicle visor apparatus is in a “full extension” mode in the vehicle interior view (300) in FIG. 3, wherein the side visor (113) is fully extended and swung downward near the driver side window, and wherein the frontal visor (111) is also fully extended and swung downward behind the front windshield to serve as dual sunshades in two directions simultaneously. In the preferred embodiment of the invention, the angle of the side visor (113) is configured to be adjusted around the side visor pivot (115) based on user preferences, while the angle of the frontal visor (111) is configured to be adjusted around the frontal visor pivot (122) held across horizontally and encapsulated by the frontal visor holder (121) and the frontal visor clip (109). Moreover, the frontal visor clip (109), which is screwed onto or firmly attached to the baseboard (101), is clipped onto the driver-side factory visor (123) in the vehicle interior view (300) in FIG. 3, with the upper portion of the frontal visor clip (109), previously illustrated in perforated lines in FIG. 1, is securely and removably clipped onto and over the driver-side factory visor (123) in FIG. 3.

In the preferred embodiment of the invention, the frontal visor clip (109) and the baseboard (101) are two separate parts attached or screwed on together. In other embodiments of the invention, the frontal visor clip (109) and the baseboard (101) may be a single molded piece or a singular part for cost efficiency and part count reductions. Similarly, in the preferred embodiment of the invention, the frontal visor (111) and the frontal visor holder (121) may be two separate parts attached together, while in other embodiments of the invention, they may be a single molded piece or a singular part for cost efficiency and part count reductions. Likewise, in the preferred embodiment of the invention, the side visor (113), the side visor pivot (115), the side visor pivot holder (117), and the sliding clip (107) may be separate parts assembled together, while in other embodiments of the invention, at least some of those parts may be combined and molded pieces for cost efficiency and part count reductions.

In the preferred embodiment of the invention, the frontal visor (111) and the side visor (113) may be partially transparent or completely opaque, depending on a manufacturer or user preference for achieving a particular level of sun intensity reduction or blockage. For example, each visor (i.e. 111 or 113) can be made of acrylic, plastic, glass, or another transparent material, and can be tinted at a specific visible light transmission (VLT) level. Furthermore, each visor may be a tinted plastic piece, a translucent plastic piece, an opaque plastic piece, or a piece made from other materials that provide substantial amount of cover from the sun's intensity. Reducing the magnitude of visible light transmission (VLT) on a visor's surface is typically achieved by darkening and/or altering the native transparency of the visor's surface. For instance, a VLT of seventy percent (70%) allows seventy percent of visible light transmission, while reducing and/or blocking thirty percent (30%) of visible light transmission through the visor's surface. In another example, a VLT of twenty percent (20%) allows twenty percent of visible light transmission, while reducing and/or blocking eighty percent (80%) of visible light transmission through the visor's surface.

In general, a tinted visor with a lower VLT number results in a darker shade level and less visible light transmission, while a higher VLT number results in a lighter shade level and more visible light transmission. By definition, a VLT of one hundred percent (100%) means a complete visible light transmissivity with total transparency, while a VLT of zero (0%) means no visible light transmissivity and a total opaqueness. Furthermore, in some embodiments of the invention, the clip-on dual swingable vehicle visor apparatus also incorporates the optional adjustment tab (119), which may be configured to adjust pivot resistance (i.e. rotation firmness) of the side visor pivot (115), lock the angle of the side visor (113), or lock the current position of the sliding clip (107) on the left-side rail (103) when the optional adjustment tab (119) is turned or twisted to a designated position.

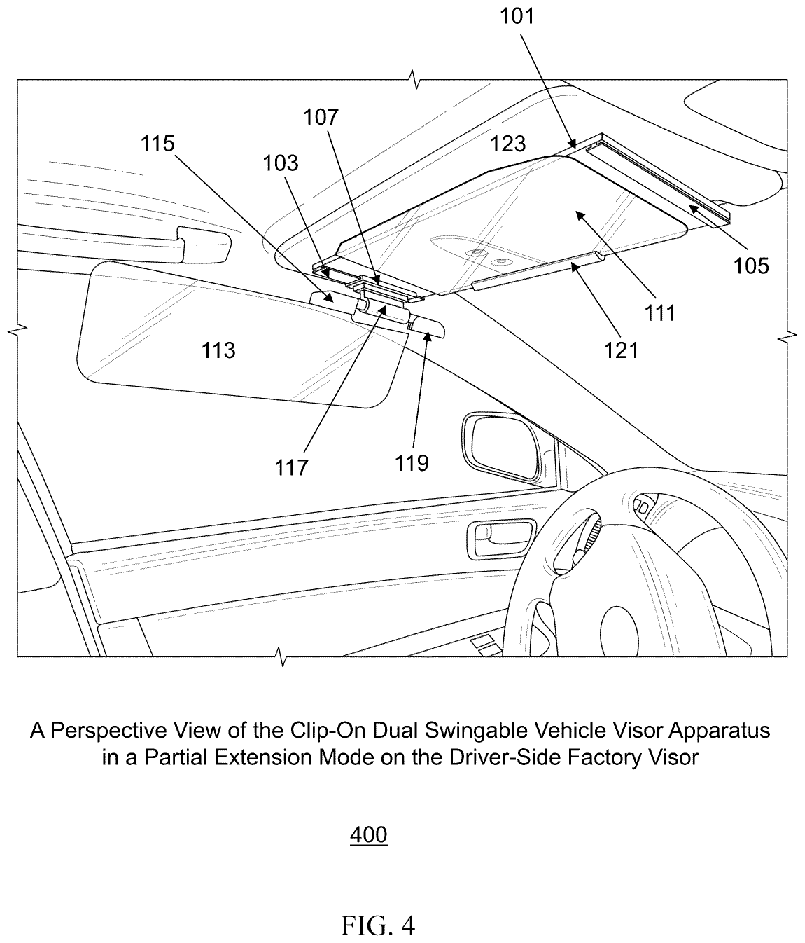

FIG. 4 shows a vehicle interior view (400) of the clip-on dual swingable vehicle visor apparatus in a partial extension mode while being clipped onto the driver-side factory visor (123), in accordance with an embodiment of the invention. In the preferred embodiment of the invention as shown in FIG. 4, the clip-on dual swingable vehicle visor apparatus comprises the baseboard (101), the frontal visor (111) operatively attached to the baseboard (101) via the frontal visor holder (121) and the frontal visor clip (i.e. 109 in FIG. 1 and FIG. 3), and the side visor (113) operatively attached to the baseboard (101) via the side visor pivot (115), the side visor pivot holder (117), and the sliding clip (107), which is slid into a secure position on the left-side rail (103) on the baseboard (101), as illustrated in FIG. 4.

In the preferred embodiment of the invention, the baseboard (101) is a plank made of plastic, rubber, wood, or another solid material. The baseboard (101) serves as a base panel of the clip-on dual swingable vehicle visor apparatus, and anchors and structurally supports the frontal visor (111) attached to the frontal visor holder (121) and the frontal visor clip (i.e. 109 in FIG. 1 and FIG. 3) with the frontal visor pivot (122), which is encapsulated by the frontal visor holder (121) and the frontal visor clip. The baseboard (101) also serves as the base panel that anchors and structurally supports the side visor (113), which is attached to the sliding clip (107) incorporating the side visor pivot holder (117) with the side visor pivot (115) that penetrates through the side visor pivot holder (117), as illustrated in FIG. 4.

In the embodiment of the invention as shown in FIG. 4, the baseboard (101) also incorporates the left-side rail (103) and the right-side rail (105) on side edges of the baseboard (101) to enable the sliding clip (107) operatively attached to the side visor (113) to be easily yet securely attached or detached from either side edges of the baseboard (101). In particular, the side visor (113) incorporating the sliding clip (107) can be easily and securely slid into or slid out of either the left-side rail (103) or the right-side rail (105), depending on a user's desired application. For example, if the user intends to utilize the clip-on dual swingable vehicle visor apparatus on a driver-side factory visor, as shown in FIG. 3˜6, then the side visor (113) incorporating the sliding clip (107) may be slid into the left-side rail (103) of the baseboard (101), as shown in FIG. 4. In contrast, if the user intends to utilize the clip-on dual swingable vehicle visor apparatus on a front passenger-side factory visor, then the side visor (113) incorporating the sliding clip (107) may be slid into the right-side rail (105) of the baseboard (101), as shown in FIG. 7˜8.

Furthermore, the clip-on dual swingable vehicle visor apparatus is in a “partial extension” mode in the vehicle interior view (400) in FIG. 4, wherein the side visor (113) remains fully extended and swung downward near the driver side window to serve as a side sunshade, and wherein the frontal visor (111) is folded upward in a retracted position and becomes parallel to the baseboard (101) of the clip-on dual swingable vehicle visor apparatus to stop serving as a frontal sunshade. In the preferred embodiment of the invention, the angle of the side visor (113) is configured to be adjusted around the side visor pivot (115) based on user preferences, while the angle of the frontal visor (111) is configured to be adjusted around the frontal visor pivot (122) held across horizontally and encapsulated by the frontal visor holder (121) and the frontal visor clip (i.e. 109 in FIG. 1 and FIG. 3).

Moreover, the frontal visor clip, which is screwed onto or firmly attached to the baseboard (101), is clipped onto the driver-side factory visor (123) in the vehicle interior view (400) in FIG. 4, with the upper portion of the frontal visor clip, previously illustrated in perforated lines in FIG. 1, is securely and removably clipped onto and over the driver-side factory visor (123) in FIG. 4. Furthermore, in some embodiments of the invention, the clip-on dual swingable vehicle visor apparatus also incorporates the optional adjustment tab (119), which may be configured to adjust pivot resistance (i.e. rotation firmness) of the side visor pivot (115), lock the angle of the side visor (113), or lock the current position of the sliding clip (107) on the left-side rail (103) when the optional adjustment tab (119) is turned or twisted to a designated position.

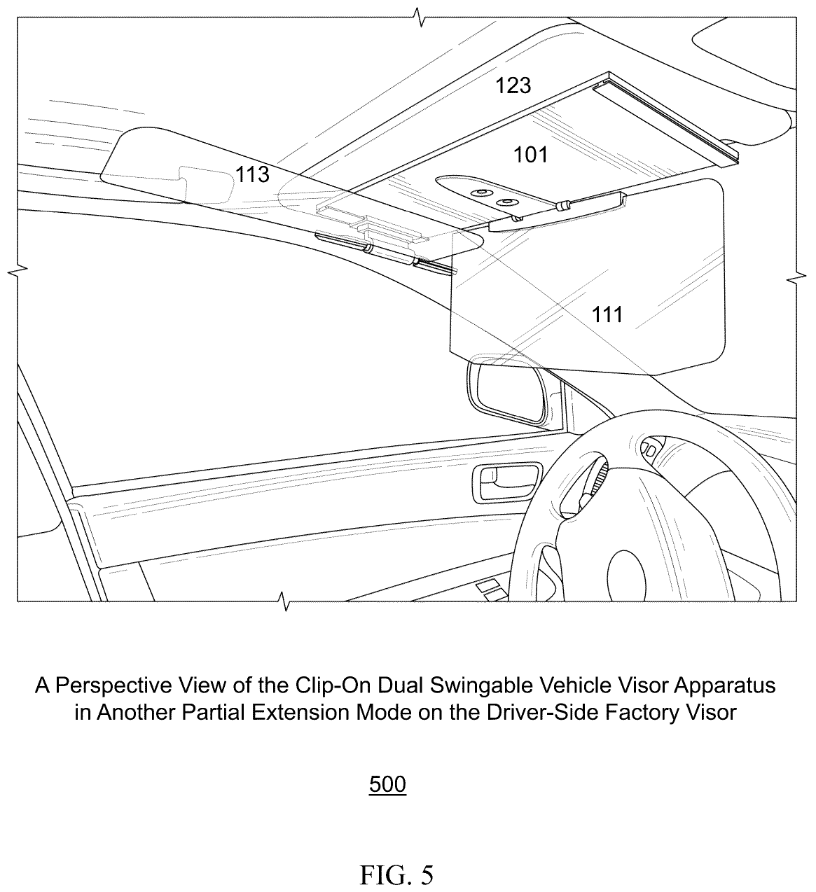

FIG. 5 shows a vehicle interior view (500) of the clip-on dual swingable vehicle visor apparatus in another partial extension mode while being clipped onto the driver-side factory visor (123), in accordance with an embodiment of the invention. In the preferred embodiment of the invention as shown in FIG. 5, the clip-on dual swingable vehicle visor apparatus comprises the baseboard (101), the frontal visor (111) operatively attached to the baseboard (101) via the frontal visor holder (i.e. 121 in FIG. 3) and the frontal visor clip (i.e. 109 in FIG. 1 and FIG. 3), and the side visor (113) operatively attached to the baseboard (101) via the side visor pivot (i.e. 115 in FIG. 3), the side visor pivot holder (i.e. 117 in FIG. 3), and the sliding clip (i.e. 107 in FIG. 3), which is slid into a secure position on the left-side rail (i.e. 103 in FIG. 3) on the baseboard (101).

In the preferred embodiment of the invention, the baseboard (101) is a plank made of plastic, rubber, wood, or another solid material. The baseboard (101) serves as a base panel of the clip-on dual swingable vehicle visor apparatus, and anchors and structurally supports the frontal visor (111) attached to the frontal visor holder (i.e. 121 in FIG. 3) and the frontal visor clip (i.e. 109 in FIG. 1 and FIG. 3) with the frontal visor pivot (122), which is encapsulated by the frontal visor holder (i.e. 121 in FIG. 3) and the frontal visor clip. The baseboard (101) also serves as the base panel that anchors and structurally supports the side visor (113), which is attached to the sliding clip (i.e. 107 in FIG. 3) incorporating the side visor pivot holder (i.e. 117 in FIG. 3) with the side visor pivot (i.e. 115 in FIG. 3) that penetrates through the side visor pivot holder.

In the embodiment of the invention as shown in FIG. 5, the baseboard (101) also incorporates the left-side rail (i.e. 103 in FIG. 3) and the right-side rail (i.e. 105 in FIG. 3) on side edges of the baseboard (101) to enable the sliding clip (i.e. 107 in FIG. 3) operatively attached to the side visor (113) to be easily yet securely attached or detached from either side edges of the baseboard (101). In particular, the side visor (113) incorporating the sliding clip (i.e. 107 in FIG. 3) can be easily and securely slid into or slid out of either the left-side rail (i.e. 103 in FIG. 3) or the right-side rail (i.e. 105 in FIG. 3), depending on a user's desired application. For example, if the user intends to utilize the clip-on dual swingable vehicle visor apparatus on a driver-side factory visor, as shown in FIG. 3˜6, then the side visor (113) incorporating the sliding clip may be slid into the left-side rail of the baseboard (101), as shown in FIG. 5. In contrast, if the user intends to utilize the clip-on dual swingable vehicle visor apparatus on a front passenger-side factory visor, then the side visor (113) incorporating the sliding clip may be slid into the right-side rail of the baseboard (101), as shown in FIG. 7˜8.

Furthermore, the clip-on dual swingable vehicle visor apparatus is in another “partial extension” mode in the vehicle interior view (500) in FIG. 5, wherein the side visor (113) is folded upward in a retracted position to stop serving as a side sunshade, and wherein the frontal visor (111) remains fully extended and swung downward behind the front windshield to serve as a frontal sunshade. In the preferred embodiment of the invention, the angle of the side visor (113) is configured to be adjusted around the side visor pivot (i.e. 115 in FIG. 3) based on user preferences, while the angle of the frontal visor (111) is configured to be adjusted around the frontal visor pivot (122) held across horizontally and encapsulated by the frontal visor holder (i.e. 121 in FIG. 3) and the frontal visor clip (i.e. 109 in FIG. 3).

Moreover, the frontal visor clip, which is screwed onto or firmly attached to the baseboard (101), is clipped onto the driver-side factory visor (123) in the vehicle interior view (500) in FIG. 5, with the upper portion of the frontal visor clip, previously illustrated in perforated lines in FIG. 1, is securely and removably clipped onto and over the driver-side factory visor (123) in FIG. 5. Furthermore, in some embodiments of the invention, the clip-on dual swingable vehicle visor apparatus also incorporates the optional adjustment tab (i.e. 119 in FIG. 3), which may be configured to adjust pivot resistance (i.e. rotation firmness) of the side visor pivot (i.e. 115 in FIG. 3), lock the angle of the side visor (113), or lock the current position of the sliding clip (i.e. 107 in FIG. 3) on the left-side rail (i.e. 103 in FIG. 3) when the optional adjustment tab is turned or twisted to a designated position.

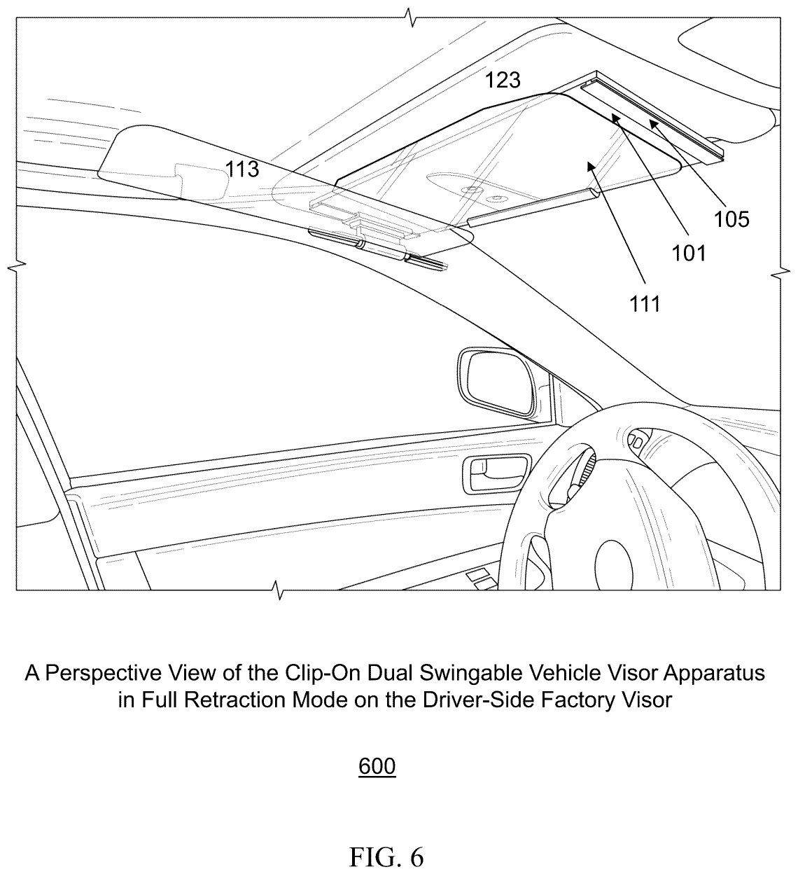

FIG. 6 shows a vehicle interior view (600) of the clip-on dual swingable vehicle visor apparatus in full retraction mode while being clipped onto the driver-side factory visor (123), in accordance with another embodiment of the invention. In the preferred embodiment of the invention as shown in FIG. 6, the clip-on dual swingable vehicle visor apparatus comprises the baseboard (101), the frontal visor (111) operatively attached to the baseboard (101) via the frontal visor holder (i.e. 121 in FIG. 3) and the frontal visor clip (i.e. 109 in FIG. 1 and FIG. 3), and the side visor (113) operatively attached to the baseboard (101) via the side visor pivot (i.e. 115 in FIG. 3), the side visor pivot holder (i.e. 117 in FIG. 3), and the sliding clip (i.e. 107 in FIG. 3), which is slid into a secure position on the left-side rail (i.e. 103 in FIG. 3) on the baseboard (101).

In the preferred embodiment of the invention, the baseboard (101) is a plank made of plastic, rubber, wood, or another solid material. The baseboard (101) serves as a base panel of the clip-on dual swingable vehicle visor apparatus, and anchors and structurally supports the frontal visor (111) attached to the frontal visor holder (i.e. 121 in FIG. 3) and the frontal visor clip (i.e. 109 in FIG. 1 and FIG. 3) with the frontal visor pivot (122), which is encapsulated by the frontal visor holder (i.e. 121 in FIG. 3) and the frontal visor clip. The baseboard (101) also serves as the base panel that anchors and structurally supports the side visor (113), which is attached to the sliding clip (i.e. 107 in FIG. 3) incorporating the side visor pivot holder (i.e. 117 in FIG. 3) with the side visor pivot (i.e. 115 in FIG. 3) that penetrates through the side visor pivot holder.

In the embodiment of the invention as shown in FIG. 6, the baseboard (101) also incorporates the left-side rail (i.e. 103 in FIG. 3) and the right-side rail (105) on side edges of the baseboard (101) to enable the sliding clip (i.e. 107 in FIG. 3) operatively attached to the side visor (113) to be easily yet securely attached or detached from either side edges of the baseboard (101). In particular, the side visor (113) incorporating the sliding clip (i.e. 107 in FIG. 3) can be easily and securely slid into or slid out of either the left-side rail (i.e. 103 in FIG. 3) or the right-side rail (105), depending on a user's desired application. For example, if the user intends to utilize the clip-on dual swingable vehicle visor apparatus on a driver-side factory visor, as shown in FIG. 3˜6, then the side visor (113) incorporating the sliding clip may be slid into the left-side rail of the baseboard (101), as shown in FIG. 6. In contrast, if the user intends to utilize the clip-on dual swingable vehicle visor apparatus on a front passenger-side factory visor, then the side visor (113) incorporating the sliding clip may be slid into the right-side rail (105) of the baseboard (101), as shown in FIG. 7˜8.

Furthermore, the clip-on dual swingable vehicle visor apparatus is in a “full retraction” mode in the vehicle interior view (600) in FIG. 6, wherein the side visor (113) and the frontal visor (111) are both folded upward in retracted positions to stop serving as side and frontal sunshades. In the preferred embodiment of the invention, the angle of the side visor (113) is configured to be adjusted around the side visor pivot (i.e. 115 in FIG. 3) based on user preferences, while the angle of the frontal visor (111) is configured to be adjusted around the frontal visor pivot (122) held across horizontally and encapsulated by the frontal visor holder (i.e. 121 in FIG. 3) and the frontal visor clip (i.e. 109 in FIG. 3).

Moreover, the frontal visor clip, which is screwed onto or firmly attached to the baseboard (101), is clipped onto the driver-side factory visor (123) in the vehicle interior view (600) in FIG. 6, with the upper portion of the frontal visor clip, previously illustrated in perforated lines in FIG. 1, is securely and removably clipped onto and over the driver-side factory visor (123) in FIG. 6. Furthermore, in some embodiments of the invention, the clip-on dual swingable vehicle visor apparatus also incorporates the optional adjustment tab (i.e. 119 in FIG. 3), which may be configured to adjust pivot resistance (i.e. rotation firmness) of the side visor pivot (i.e. 115 in FIG. 3), lock the angle of the side visor (113), or lock the current position of the sliding clip (i.e. 107 in FIG. 3) on the left-side rail (i.e. 103 in FIG. 3) when the optional adjustment tab is turned or twisted to a designated position.

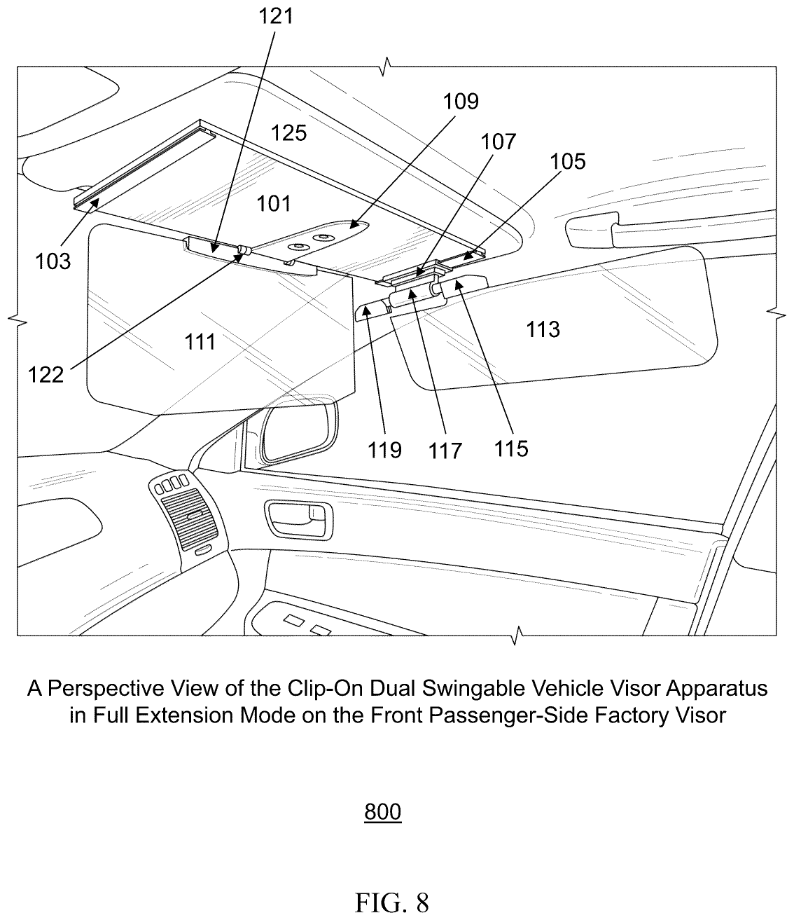

FIG. 7 shows a vehicle interior view (700) of the clip-on dual swingable vehicle visor apparatus in full retraction mode while being clipped onto a front passenger-side factory visor (125), in accordance with another embodiment of the invention. In the preferred embodiment of the invention as shown in FIG. 7, the clip-on dual swingable vehicle visor apparatus comprises the baseboard (101), the frontal visor (111) operatively attached to the baseboard (101) via the frontal visor holder (i.e. 121 in FIG. 8) and the frontal visor clip (i.e. 109 in FIG. 8), and the side visor (113) operatively attached to the baseboard (101) via the side visor pivot (i.e. 115 in FIG. 8), the side visor pivot holder (i.e. 117 in FIG. 8), and the sliding clip (i.e. 107 in FIG. 8), which is slid into a secure position on the right-side rail (i.e. 105 in FIG. 8) on the baseboard (101).

In the preferred embodiment of the invention, the baseboard (101) is a plank made of plastic, rubber, wood, or another solid material. The baseboard (101) serves as a base panel of the clip-on dual swingable vehicle visor apparatus, and anchors and structurally supports the frontal visor (111) attached to the frontal visor holder (i.e. 121 in FIG. 8) and the frontal visor clip (i.e. 109 in FIG. 8) with the frontal visor pivot (122), which is encapsulated by the frontal visor holder (i.e. 121 in FIG. 8) and the frontal visor clip (i.e. 109 in FIG. 8). The baseboard (101) also serves as the base panel that anchors and structurally supports the side visor (113), which is attached to the sliding clip (i.e. 107 in FIG. 8) incorporating the side visor pivot holder (i.e. 117 in FIG. 8) with the side visor pivot (i.e. 115 in FIG. 8) that penetrates through the side visor pivot holder.

In the embodiment of the invention as shown in FIG. 7, the baseboard (101) also incorporates the left-side rail (103) and the right-side rail (i.e. 105 in FIG. 8) on side edges of the baseboard (101) to enable the sliding clip (i.e. 107 in FIG. 8) operatively attached to the side visor (113) to be easily yet securely attached or detached from either side edges of the baseboard (101). In particular, the side visor (113) incorporating the sliding clip (i.e. 107 in FIG. 8) can be easily and securely slid into or slid out of either the left-side rail (103) or the right-side rail (i.e. 105 in FIG. 8), depending on a user's desired application. For example, if the user intends to utilize the clip-on dual swingable vehicle visor apparatus on a front passenger-side factory visor, then the side visor (113) incorporating the sliding clip may be slid into the right-side rail (i.e. 105 in FIG. 8) of the baseboard (101), as shown in FIG. 7˜8. In contrast, if the user intends to utilize the clip-on dual swingable vehicle visor apparatus on a driver-side factory visor as shown in FIG. 3˜6, then the side visor (113) incorporating the sliding clip may be slid into the left-side rail (103) of the baseboard (101).

Furthermore, the clip-on dual swingable vehicle visor apparatus is in a “full retraction” mode while being clipped on the front passenger-side factory visor (125) in the vehicle interior view (700) in FIG. 7, wherein the side visor (113) and the frontal visor (111) are both folded upward in retracted positions to stop serving as side and frontal sunshades. In the preferred embodiment of the invention, the angle of the side visor (113) is configured to be adjusted around the side visor pivot (i.e. 115 in FIG. 8) based on user preferences, while the angle of the frontal visor (111) is configured to be adjusted around the frontal visor pivot (122) held across horizontally and encapsulated by the frontal visor holder (i.e. 121 in FIG. 8) and the frontal visor clip (i.e. 109 in FIG. 8).

Moreover, the frontal visor clip, which is screwed onto or firmly attached to the baseboard (101), is clipped onto the front passenger-side factory visor (125) in the vehicle interior view (700) in FIG. 7, with the upper portion of the frontal visor clip, previously illustrated in perforated lines in FIG. 1, is securely and removably clipped onto and over the front passenger-side factory visor (125) in FIG. 7. Furthermore, in some embodiments of the invention, the clip-on dual swingable vehicle visor apparatus also incorporates the optional adjustment tab (i.e. 119 in FIG. 8), which may be configured to adjust pivot resistance (i.e. rotation firmness) of the side visor pivot (i.e. 115 in FIG. 8), lock the angle of the side visor (113), or lock the current position of the sliding clip (i.e. 107 in FIG. 8) on the right-side rail (i.e. 105 in FIG. 8) when the optional adjustment tab is turned or twisted to a designated position.

FIG. 8 shows a vehicle interior view (800) of the clip-on dual swingable vehicle visor apparatus in full extension mode while being clipped onto the front passenger-side factory visor (125), in accordance with another embodiment of the invention. In the preferred embodiment of the invention as shown in FIG. 8, the clip-on dual swingable vehicle visor apparatus comprises the baseboard (101), the frontal visor (111) operatively attached to the baseboard (101) via the frontal visor holder (121) and the frontal visor clip (109), and the side visor (113) operatively attached to the baseboard (101) via the side visor pivot (115), the side visor pivot holder (117), and the sliding clip (107), which is slid into a secure position on the right-side rail (105) on the baseboard (101).

In the preferred embodiment of the invention, the baseboard (101) is a plank made of plastic, rubber, wood, or another solid material. The baseboard (101) serves as a base panel of the clip-on dual swingable vehicle visor apparatus, and anchors and structurally supports the frontal visor (111) attached to the frontal visor holder (121) and the frontal visor clip (109) with the frontal visor pivot (122), which is encapsulated by the frontal visor holder (121) and the frontal visor clip (109). The baseboard (101) also serves as the base panel that anchors and structurally supports the side visor (113), which is attached to the sliding clip (107) incorporating the side visor pivot holder (117) with the side visor pivot (115) that penetrates through the side visor pivot holder.

In the embodiment of the invention as shown in FIG. 8, the baseboard (101) also incorporates the left-side rail (103) and the right-side rail (105) on side edges of the baseboard (101) to enable the sliding clip (107) operatively attached to the side visor (113) to be easily yet securely attached or detached from either side edges of the baseboard (101). In particular, the side visor (113) incorporating the sliding clip (107) can be easily and securely slid into or slid out of either the left-side rail (103) or the right-side rail (105), depending on a user's desired application. For example, if the user intends to utilize the clip-on dual swingable vehicle visor apparatus on the front passenger-side factory visor (125), then the side visor (113) incorporating the sliding clip may be slid into the right-side rail (105) of the baseboard (101), as shown in FIG. 7˜8. In contrast, if the user intends to utilize the clip-on dual swingable vehicle visor apparatus on the driver-side factory visor (i.e. 123 in FIG. 3) as shown in FIG. 3˜6, then the side visor (113) incorporating the sliding clip may be slid into the left-side rail (103) of the baseboard (101).

Furthermore, the clip-on dual swingable vehicle visor apparatus is in a “full extension” mode while being clipped on the front passenger-side factory visor (125) in the vehicle interior view (800) in FIG. 8, wherein the side visor (113) and the frontal visor (111) are both swung downward in fully-extended positions to serve as side and frontal sunshades simultaneously in two dimensions. In the preferred embodiment of the invention, the angle of the side visor (113) is configured to be adjusted around the side visor pivot (115) based on user preferences, while the angle of the frontal visor (111) is configured to be adjusted around the frontal visor pivot (122) held across horizontally and encapsulated by the frontal visor holder (121) and the frontal visor clip (109).

Moreover, the frontal visor clip (109), which is screwed onto or firmly attached to the baseboard (101), is clipped onto the front passenger-side factory visor (125) in the vehicle interior view (800) in FIG. 8, with the upper portion of the frontal visor clip, previously illustrated in perforated lines in FIG. 1, is securely and removably clipped onto and over the front passenger-side factory visor (125) in FIG. 8. Furthermore, in some embodiments of the invention, the clip-on dual swingable vehicle visor apparatus also incorporates the optional adjustment tab (119), which may be configured to adjust pivot resistance (i.e. rotation firmness) of the side visor pivot (115), lock the angle of the side visor (113), or lock the current position of the sliding clip (107) on the right-side rail (105) when the optional adjustment tab is turned or twisted to a designated position.

In the preferred embodiment of the invention, the frontal visor clip (109) and the baseboard (101) are two separate parts attached or screwed on together. In other embodiments of the invention, the frontal visor clip (109) and the baseboard (101) may be a single molded piece or a singular part for cost efficiency and part count reductions. Similarly, in the preferred embodiment of the invention, the frontal visor (111) and the frontal visor holder (121) may be two separate parts attached together, while in other embodiments of the invention, they may be a single molded piece or a singular part for cost efficiency and part count reductions. Likewise, in the preferred embodiment of the invention, the side visor (113), the side visor pivot (115), the side visor pivot holder (117), and the sliding clip (107) may be separate parts assembled together, while in other embodiments of the invention, at least some of those parts may be combined and molded pieces for cost efficiency and part count reductions.

In the preferred embodiment of the invention, the frontal visor (111) and the side visor (113) may be partially transparent or completely opaque, depending on a manufacturer or user preference for achieving a particular level of sun intensity reduction or blockage. For example, each visor (i.e. 111 or 113) can be made of acrylic, plastic, glass, or another transparent material, and can be tinted at a specific visible light transmission (VLT) level. Furthermore, each visor may be a tinted plastic piece, a translucent plastic piece, an opaque plastic piece, or a piece made from other materials that provide substantial amount of cover from the sun's intensity.

Reducing the magnitude of visible light transmission (VLT) on a visor's surface is typically achieved by darkening and/or altering the native transparency of the visor's surface. For instance, a VLT of seventy percent (70%) allows seventy percent of visible light transmission, while reducing and/or blocking thirty percent (30%) of visible light transmission through the visor's surface. In another example, a VLT of twenty percent (20%) allows twenty percent of visible light transmission, while reducing and/or blocking eighty percent (80%) of visible light transmission through the visor's surface. In general, a tinted visor with a lower VLT number results in a darker shade level and less visible light transmission, while a higher VLT number results in a lighter shade level and more visible light transmission. By definition, a VLT of one hundred percent (100%) means a complete visible light transmissivity with total transparency, while a VLT of zero (0%) means no visible light transmissivity and a total opaqueness.

Various embodiments of the present invention, as described above, provide several advantages over conventional aftermarket sunshades. For example, a novel clip-on dual swingable vehicle visor apparatus in accordance with an embodiment of the invention reduces driver distraction and improves driver and passenger safety by not requiring the driver to manually remove an aftermarket sunshade attached to a side window before the window is opened or closed. Because the novel clip-on dual swingable vehicle visor apparatus does not dislocate or dislodge even when a side window is opened or closed, the present invention also provides additional user convenience while reducing the driver distraction.

Furthermore, a novel clip-on dual swingable vehicle visor apparatus, in accordance with an embodiment of the invention, forms a unique multidimensional and dual sun visor structure, which provides simultaneous multidimensional sun blockage or sunshade while in use, and can be folded or stored together with the existing standard in-car sun visor while not in use. Moreover, a novel attachable and removable vehicle visor apparatus incorporating dual tinted visors, in accordance with an embodiment of the invention, provides a sun-shaded (i.e. tinted) and/or translucent view of the front windshield and the side window simultaneously, instead of potentially hampering the user's line of sight by completely blocking the sunlight with a conventional opaque standard in-car sun visor. In addition, a novel attachable and removable vehicle visor apparatus incorporating dual tinted visors, in accordance with an embodiment of the invention, accommodates various shade levels (i.e. visible light transmission (VLT) levels ranging from slight tinting to fully opaque) on the dual tinted visors based on user preferences or application requirements.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A clip-on dual swingable vehicle visor apparatus comprising:
a baseboard configured to be clipped onto a standard in-car sun visor and positioned in parallel above or below the standard in-car sun visor;
a left-side rail incorporated in a left-side edge of the baseboard, and a right-side rail incorporated in a right-side edge of the baseboard;
a sliding clip configured to slide into and slide out of the left-side rail or the right-side rail of the baseboard;
a side visor operatively attached to the sliding clip as a removable side visor structure, wherein the sliding clip in the removable side visor structure is configured to dock into the left-side rail to operate as a driver-side or left-side sunshade in a first usage application, and wherein the sliding clip in the removable side visor structure is configured to dock into the right-side rail to operate as a front passenger-side or right-side sunshade in a second usage application;
a frontal visor operatively attached to the baseboard to serve as a frontal sunshade; and
a frontal visor clip operatively attached to the baseboard, wherein the frontal visor clip is configured to bind the baseboard to the standard in-car sun visor by clipping the baseboard onto a bottom or top surface of the standard in-car sun visor.

2. The clip-on dual swingable vehicle visor apparatus of claim 1, further comprising a side visor pivot and a side visor pivot holder attached to or forming a top edge of the side visor, wherein the side visor pivot at least partly encapsulated by the side visor pivot holder enables the side visor to swing laterally around the side visor pivot, when a user makes a side sunshade angle adjustment.

3. The clip-on dual swingable vehicle visor apparatus of claim 1, further comprising a frontal visor holder attached to or forming a top edge of the frontal visor, wherein the frontal visor holder at least partly encapsulates a frontal visor pivot that enables the frontal visor to swing forward or backward around the frontal visor pivot, when a user makes a frontal sunshade angle adjustment.

4. The clip-on dual swingable vehicle visor apparatus of claim 2, further comprising an adjustment tab on the removable side visor structure, wherein the adjustment tab controls and changes a rotation firmness of the side visor pivot.

5. The clip-on dual swingable vehicle visor apparatus of claim 1, further comprising an adjustment tab on the removable side visor structure, wherein the adjustment tab locks a current position of the sliding clip on the left-side rail or the right-side rail when the adjustment tab is turned or twisted to a designated position.

6. The clip-on dual swingable vehicle visor apparatus of claim 1, wherein the baseboard is made of plastic, rubber, wood, or another solid material.

7. The clip-on dual swingable vehicle visor apparatus of claim 1, wherein the frontal visor and the side visor are each made of acrylic, plastic, glass, or another transparent material, and wherein the frontal visor and the side visor are each tinted at a specific visible light transmission (VLT) level to reduce or block solar energy and visible light transmissivity through each visor.

8. The clip-on dual swingable vehicle visor apparatus of claim 1, wherein the side visor and the sliding clip comprising the removable side visor structure are two separate pieces attached together.

9. The clip-on dual swingable vehicle visor apparatus of claim 1, wherein the side visor and the sliding clip comprising the removable side visor structure are a singularly-molded plastic or acrylic component for cost-effective manufacturing.

10. The clip-on dual swingable vehicle visor apparatus of claim 1, wherein the frontal visor and the side visor are either extended downward to operate as sunshades independently of each other, or retracted and folded upward independently of each other, based on user preferences.

11. The clip-on dual swingable vehicle visor apparatus of claim 1, wherein the standard in-car visor is a driver-side factory visor or a front passenger-side factory visor.

12. The clip-on dual swingable vehicle visor apparatus of claim 1, wherein the left-side rail, the right-side rail, and the sliding clip utilize magnetic elements, Velcro strips, buttons, hooks, or fasteners as methods of removable side visor attachments on either side edges of the baseboard.

13. The clip-on dual swingable vehicle visor apparatus of claim 1, wherein the frontal visor is operatively attached to the baseboard with a frontal rail, a frontal sliding clip, magnetic elements, Velcro strips, buttons, hooks, or fasteners.
